(19) United States
(12) Patent Application Publication
(10) Pub. No.: US 2026/0063807 A1
(43) Pub. Date: Mar. 5, 2026

(54) POSITION MANAGEMENT METHOD, OPERATION METHOD FOR SERVER, NON-TRANSITORY COMPUTER-READABLE STORAGE MEDIUM STORING PROGRAM, AND POSITION MANAGEMENT SYSTEM

(71) Applicant: SEIKO EPSON CORPORATION, Tokyo (JP)

(72) Inventor: Naoki GOBARA, SHIOJIRI-SHI (JP)

(73) Assignee: SEIKO EPSON CORPORATION, Tokyo (JP)

(21) Appl. No.: 19/309,630

(22) Filed: Aug. 26, 2025

(30) Foreign Application Priority Data
Aug. 27, 2024 (JP) 2024-145266

(51) Int. Cl. G01S 19/39; G01S 19/42

(52) U.S. Cl. CPC G01S 19/393; G01S 19/42

(57) ABSTRACT

A position management method including a measurement terminal generating measurement information including information concerning a position of a target person, a server acquiring the measurement information transmitted from the measurement terminal, the server determining, based on course information, whether a leading first course point of a predicted movement range from a course point set as a last position on a course of the target person is included in a first range from a check point, and, when the first course point is not included in the first range from the check point, the server setting, among a plurality of course points included in the predicted movement range and a range from the first course point to the check point, a course point closest to the position as a current position on the course of the target person.

The present application is based on, and claims priority from JP Application Serial Number 2024-145266, filed Aug. 27, 2024, the disclosure of which is hereby incorporated by reference herein in its entirety.

### BACKGROUND

### 1. Technical Field

The present disclosure relates to a position management method, an operation method of a server, a non-transitory computer-readable storage medium storing a program, and a position management system.

### 2. Related Art

JP-A-2015-105877 describes a wrist terminal that acquires position information based on a signal received from a GPS satellite, determines whether the acquired position information is within an error range of a GPS in course information, corrects a position based on the course information when determining that the position information is within the error range of the GPS, and sets the corrected position as a position of the wrist terminal.

JP-A-2015-105877 is an example of the related art.

However, in the wrist terminal described in JP-A-2015-105877, when an error of the GPS is large, a position after a check point such as a turning point is likely to be set as the position of the wrist terminal, although a user has not reached the check point.

### SUMMARY

A position management method according to an aspect of the present disclosure is a position management method for managing a position on a course of a target person, the method including:
a measurement terminal measuring a position of the target person and generating measurement information including information concerning the measured position;
the measurement terminal transmitting the measurement information to a server;
the server acquiring the measurement information transmitted from the measurement terminal;
the server determining, based on course information including coordinates of a plurality of course points including a check point on the course, whether a first course point, which is a leading course point in a predicted movement range from a course point set as a last position on the course of the target person among the plurality of course points, is included in a first range from the check point; and
when the first course point is not included in the first range from the check point, the server setting, based on the course information and the measurement information, among a plurality of course points included in the predicted movement range and a range from the first course point to the check point, a course point closest to the measured position as a current position on the course of the target person.

A position management method according to another aspect of the present disclosure is a position management method for managing a position on a course of a target person, the position management method including:
acquiring measurement information including information concerning the position of the target person;
determining, based on course information including coordinates of a plurality of course points including a check point on the course, whether a first course point, which is a leading course point in a predicted movement range from a course point set as a last position on the course of the target person among the plurality of course points, is included in a first range from the check point; and
when the first course point is not included in the first range from the check point, setting, based on the course information and the measurement information, among a plurality of course points included in the predicted movement range and a range from the first course point to the check point, a course point closest to the measured position as a current position on the course of the target person.

An operation method of a server according to another aspect of the present disclosure is an operation method of a server for storing course information including coordinates of a plurality of course points including a check point on a course, the operation method including:
acquiring measurement information including information concerning a position of a target person transmitted from a measurement terminal;
determining, based on the course information, whether a first course point, which is a leading course point in a predicted movement range from a course point set as a last position on the course of the target person among the plurality of course points, is included in a first range from the check point; and
when the first course point is not included in the first range from the check point, setting, based on the course information and the measurement information, among a plurality of course points included in the predicted movement range and a range from the first course point to the check point, a course point closest to the measured position as a current position on the course of the target person.

A non-transitory computer-readable storage medium stores a program according to another aspect of the present disclosure that causes a computer to execute the operation method of the server.

A position management system according to another aspect of the present disclosure is a position management system that manages a position on a course of a target person, the position management system including:
a measurement terminal; and
a server, wherein
the measurement terminal includes:
   a measurement information generation unit configured to measure a position of the target person and generate measurement information including information concerning the measured position; and
   a communication unit configured to transmit the measurement information to the server, and
the server includes:
   a data storage unit configured to store course information including coordinates of a plurality of course points including a check point on the course;
   a measurement information acquisition unit configured to acquire the measurement information transmitted from the measurement terminal; and
   a course matching processing unit configured to determine, based on the course information, whether a first course point, which is a leading course point in a predicted movement range from a course point set as a last position on the course of the target person among the plurality of course points, is included in a first range from the check point and, when the first course point is not included in the first range from the check point, set, based on the course information and the measurement information, among a plurality of course points included in the predicted movement range and a range from the first course point to the check point, a course point closest to the measured position as a current position on the course of the target person.

### BRIEF DESCRIPTION OF THE DRAWINGS

FIG. 1 is a diagram illustrating a configuration example of a position management system in a first embodiment.

FIG. 2 is a diagram illustrating an overview of the position management system.

FIG. 3 is a diagram illustrating an example of an image displayed on a display terminal.

FIG. 4 is a functional block diagram of a measurement terminal.

FIG. 5 is a functional block diagram of a server.

FIG. 6 is a diagram illustrating an example of course information.

FIG. 7 is a diagram illustrating an example of a time series of measurement information.

FIG. 8 is a diagram of course matching processing.

FIG. 9 is a diagram illustrating an example of a relationship between course points and measured positions in the first embodiment.

FIG. 10 is a diagram illustrating an example of course matching processing in a comparative example.

FIG. 11 is a diagram illustrating an example of course matching processing in the first embodiment.

FIG. 12 is a flowchart illustrating a procedure of a position management method.

FIG. 13 is a flowchart illustrating an example of a procedure of the course matching processing in the first embodiment.

FIG. 14 is a diagram illustrating an example of a time series of measurement information in a second embodiment.

FIG. 15 is a diagram illustrating an example of a relationship between course points and measured positions in the second embodiment.

FIG. 16 is a diagram illustrating an example of course matching processing in the second embodiment.

FIG. 17 is a flowchart illustrating an example of a procedure of the course matching processing in the second embodiment.

### DESCRIPTION OF EMBODIMENTS

Preferred embodiments of the present disclosure are explained in detail below with reference to the drawings. Note that the embodiments explained below do not unreasonably limit the content of the present disclosure described in the claims. Not all of the components explained below are always essential elements of the present disclosure.

### 1. First Embodiment

### 1-1. Configuration of a Position Management System

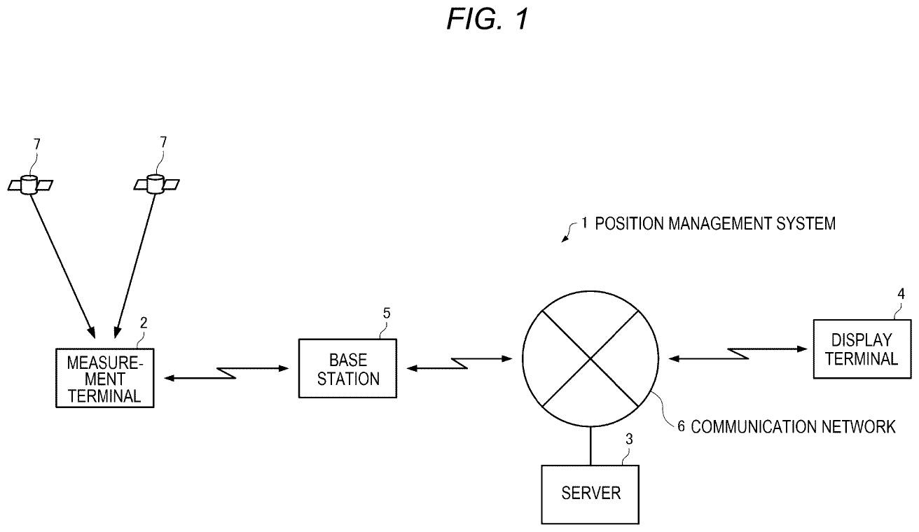

FIG. 1 is a diagram illustrating a configuration example of a position management system 1 in a first embodiment. As illustrated in FIG. 1, the position management system 1 in the present embodiment includes a measurement terminal 2, a server 3, and a display terminal 4. The server 3 and the display terminal 4 are connected to a communication network 6 such as the Internet or a LAN. LAN is an abbreviation for Local Area Network.

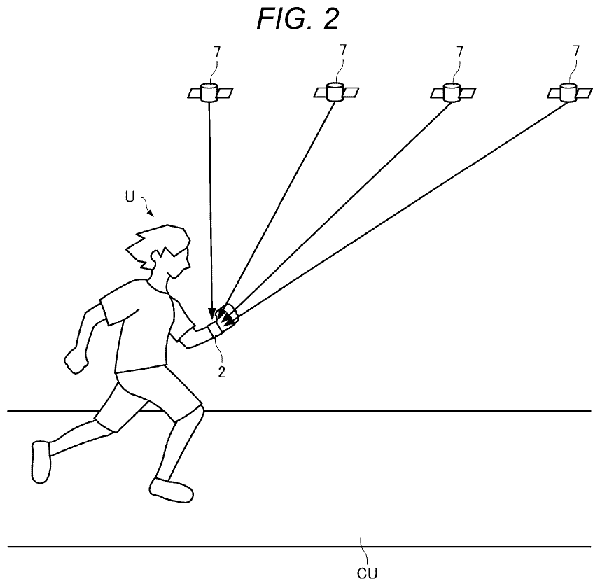

As illustrated in FIG. 2, a target person U who is a target of position management by the position management system 1 carries the measurement terminal 2 and moves on a predetermined course CU. The measurement terminal 2 may be worn on any part such as a wrist of the target person U or may be attached to clothing, number cloth, or the like of the target person U. In the following explanation, the position management system 1 is explained assuming that the target person U is an athlete participating in a marathon race of running on a course CU. However, the target person U is not limited to the marathon athlete and may be, for example, an athlete of a walking race, a triathlon, a bicycle race, or the like.

The measurement terminal 2 generates measurement information including position information at a predetermined period based on satellite signals transmitted from each of a plurality of satellites 7. Since the measurement terminal 2 moves together with the target person U, the measurement terminal 2 generates measurement information including information concerning the position of the target person U. The measurement terminal 2 may be dedicated equipment that generates measurement information including position information, or may be portable equipment such as a smartphone or a smart watch. The satellite 7 is an artificial satellite orbiting a predetermined orbit above the earth and configures a part of a GNSS. GNSS is an abbreviation for Global Navigation Satellite System. Examples of the GNSS include GPS, QZSS, EGNOS, GLONASS, GALILEO, and BeiDou. GPS is an abbreviation for Global Positioning System. QZSS is an abbreviation for Quasi Zenith Satellite System. EGNOS is an abbreviation for European Geostationary Navigation Overlay Service. GLONASS is an abbreviation for Global Navigation Satellite System.

The measurement terminal 2 wirelessly transmits the generated measurement information to a base station 5. The base station 5 is connected to the communication network 6 and transmits the received measurement information to the server 3 through the communication network 6. The server 3 acquires the measurement information transmitted from the measurement terminal 2, performs course matching processing based on the acquired measurement information and course information stored in advance, and sets the position on the course CU of the target person U. The server 3 transmits information concerning the set position on the course CU to the display terminal 4 through the communication network 6.

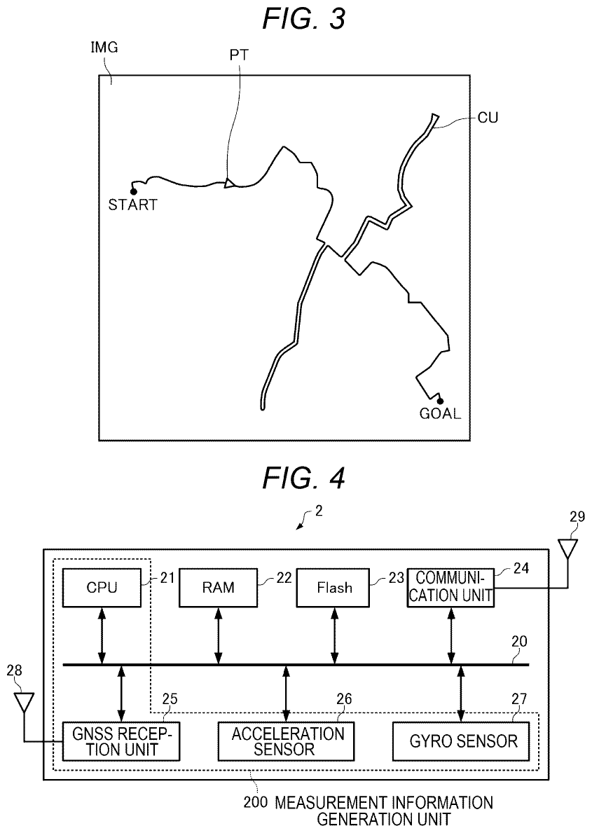

The display terminal 4 only has to be electronic equipment having a display function, such as a personal computer, a smartphone, or a tablet device. A user of the display terminal 4 is capable of viewing an image including information such as the position on the course CU of the target person U by accessing a specific web page. FIG. 3 is a diagram illustrating an example of an image displayed on the display terminal 4. An image IMG illustrated in FIG. 3 includes an icon PT indicating the position on the course CU of the target person U together with an image indicating a path from a start to a goal of the course CU. The user of the display terminal 4 can also enlarge and display a part of the course CU. The icon PT is updated, for example, every five seconds or every one second and moves on the course CU. When the icon PT is clicked, detailed information such as a position coordinate and speed of the target person U is displayed. The user of the display terminal 4 can grasp a running situation of the target person U with the image IMG. A plurality of athletes participating in a marathon race may be respectively set as target persons U and the positions on the course CU of the plurality of target persons U may be simultaneously displayed on the display terminal 4.

### 1-2. Functional Configuration of the Measurement Terminal

FIG. 4 is an example of a functional block diagram of the measurement terminal 2. As illustrated in FIG. 4, the measurement terminal 2 includes a CPU 21, a RAM 22, a flash memory 23, a communication unit 24, a GNSS reception unit 25, an acceleration sensor 26, a gyro sensor 27, and antennas 28 and 29. CPU is an abbreviation for Central Processing Unit. RAM is an abbreviation for Random Access Memory. In the measurement terminal 2, some of these elements may be deleted or changed or other elements may be added.

The CPU 21 controls the RAM 22, the flash memory 23, the communication unit 24, the GNSS reception unit 25, the acceleration sensor 26, and the gyro sensor 27 via a data bus 20, and exchanges various data with these units.

The antenna 28 is an antenna that receives radio waves including satellite signals transmitted from each of the plurality of satellites 7 and is coupled to the GNSS reception unit 25. The GNSS reception unit 25 receives, via the antenna 28, a plurality of satellite signals transmitted from the plurality of satellites 7 and performs positioning at a predetermined period based on the received satellite signals.

The acceleration sensor 26 detects accelerations in three axis directions orthogonal to one another that define a three-dimensional coordinate space provided in the measurement terminal 2. The gyro sensor 27 detects angular velocities around the three axes.

The CPU 21 acquires positioning data of the GNSS reception unit 25 at a predetermined period. The CPU 21 acquires, at a predetermined period, three-axis acceleration data detected by the acceleration sensor 26 and three-axis angular velocity data detected by the gyro sensor 27 and estimates the position of the measurement terminal 2 with a publicly-known method that is based on the acquired three-axis acceleration data and three-axis angular velocity data. Further, the CPU 21 calculates the position of the measurement terminal 2 with publicly-known composite navigation in which the positioning data and the position estimated based on the three-axis acceleration data and the three-axis angular velocity data are used. The CPU 21 may calculate the speed of the measurement terminal 2 based on the position of the measurement terminal 2. Then, the CPU 21 links the calculated position and the calculated speed and a time to generate measurement information and stores the generated measurement information in the flash memory 23. As explained above, the CPU 21, the GNSS reception unit 25, the acceleration sensor 26, and the gyro sensor 27 configure a measurement information generation unit 200 that generates measurement information.

Besides the measurement information, the flash memory 23 also stores setting information of the measurement terminal 2 such as a positioning period of the GNSS reception unit 25 and sampling periods of the acceleration sensor 26 and the gyro sensor 27. The RAM 22 is used as, for example, a work area of the CPU 21 and temporarily stores data of a calculation result of the CPU 21.

The antenna 29 is an antenna that transmits and receives radio waves to and from the base station 5 and is coupled to the communication unit 24. The communication unit 24 transmits the measurement information stored in the flash memory 23 to the base station 5 via the antenna 29. The base station 5 transmits the received measurement information to the server 3 through the communication network 6. That is, the communication unit 24 transmits the measurement information to the server 3 via the antenna 29, the base station 5, and the communication network 6. The base station 5 acquires the setting information of the measurement terminal 2 from the server 3 through the communication network 6 and transmits the setting information to the measurement terminal 2. The CPU 21 acquires, via the communication unit 24, the setting information received by the antenna 29 and stores the setting information in the flash memory 23.

### 1-3. Functional Configuration of the Server

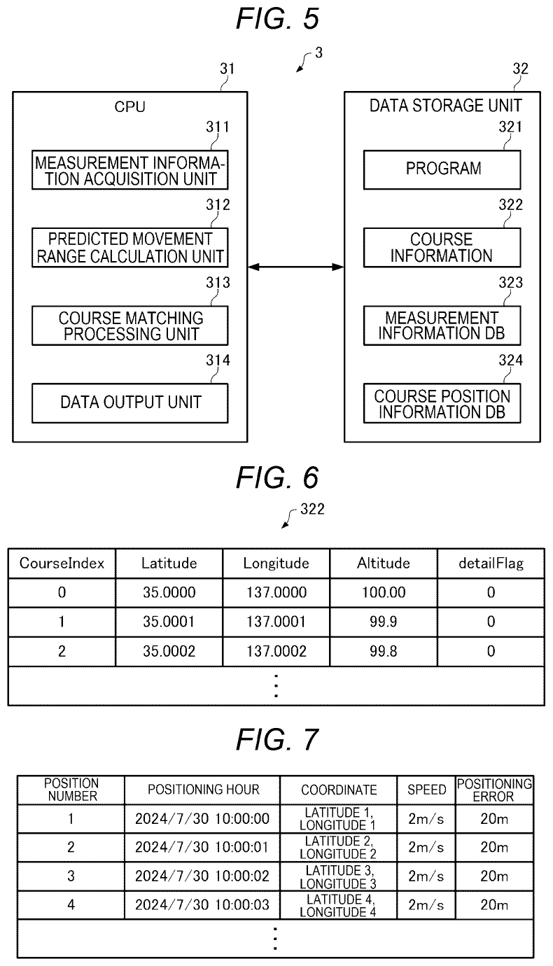

FIG. 5 is an example of a functional block diagram of the server 3. As illustrated in FIG. 5, the server 3 includes a CPU 31 and a data storage unit 32. In the server 3, some of these elements may be deleted or changed or other elements may be added.

The data storage unit 32 stores a program 321, course information 322, a measurement information database 323, and a course position information database 324.

The course information 322 is information including coordinates of a plurality of course points including a check point on the course CU. An example of the course information 322 is illustrated in FIG. 6. The course information 322 illustrated in FIG. 6 includes CourseIndex for identifying the course points, longitude, latitude, and altitude that are coordinates of the course points, and detailFlag. The detailFlag is a flag indicating whether the course points are check points and means that a course point where the detailFlag is 1 is a check point, and a course point where the detailFlag is 0 is not a check point. For example, the check point is a turning point.

The CPU 31 performs processing of managing the positions of the target persons U. In the present embodiment, the CPU 31 executes the program 321 to function as a measurement information acquisition unit 311, a predicted movement range calculation unit 312, a course matching processing unit 313, and a data output unit 314. That is, the server 3 includes the measurement information acquisition unit 311, the predicted movement range calculation unit 312, the course matching processing unit 313, and the data output unit 314.

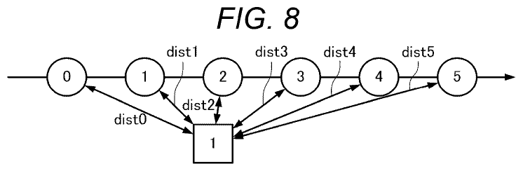

The measurement information acquisition unit 311 acquires measurement information transmitted from the measurement terminals 2 carried by the target persons U and stores the acquired measurement information in the measurement information database 323. That is, measurement information generated by the measurement terminals 2 is stored in time series in the measurement information database 323. FIG. 7 illustrates an example of the time series of the measurement information stored in the measurement information database 323. As illustrated in FIG. 7, pieces of measurement information respectively include information concerning position numbers, positioning times, and coordinates of the positions of the target person U. In the example illustrated in FIG. 7, the measurement information acquisition unit 311 acquires the measurement information at one second period and the positioning time included in the measurement information increases one second at a time. Further, as illustrated in FIG. 7, the respective pieces of measurement information may respectively include information concerning the speeds and the positioning errors of the target person U.

The predicted movement range calculation unit 312 calculates, based on the measurement information acquired by the measurement information acquisition unit 311, a predicted movement range from a first course point that is a course point set as the last position on the course CU of the target person U. For example, when the measurement information includes information concerning a positioning error, the predicted movement range calculation unit 312 may calculate the predicted movement range based on the positioning error. Specifically, the predicted movement range calculation unit 312 calculates a predicted movement range in which the course point farther from the first course point is included as the positioning error is larger. The world record of the full marathon of 42.195 km is approximately two hours and an average distance that the fastest runner runs in one second is approximately 5.8 m. When a plurality of course points are set at intervals of 1.0 m and it is assumed that an upper limit of a distance that the target person U runs in one second is 8 m, the target person U passes a maximum of eight course points in one second. Further, when it is assumed that a positioning period of the measurement terminal 2 is one second, in the example illustrated in FIG. 7, since the positioning error included in the measurement information is 20 m, a maximum of twenty course points are included as errors in one positioning period. Therefore, the predicted movement range calculation unit 312 may include, in the predicted movement range, twenty-eight points ahead of the currently set course point.

For example, when the measurement information includes information concerning the speed of the target person U, the predicted movement range calculation unit 312 may calculate the predicted movement range based on the speed of the target person U. Specifically, the predicted movement range calculation unit 312 calculates a predicted movement range in which the course point farther from the first course point is included as the speed of the target person U is higher.

The predicted movement range may include a fixed number of course points regardless of the speed or the positioning error. For example, when it is assumed that the positioning error of the measurement terminal 2 is 20 m, twenty-eight points ahead of the currently set course point may be included in the predicted movement range every time. In this case, the measurement information may not include information concerning the speed and the positioning error and the server 3 may not include the predicted movement range calculation unit 312.

The course matching processing unit 313 sets one course point among a plurality of course points as the position on the course CU of the target person U based on the course information 322 and the measurement information. Specifically, the course matching processing unit 313 sets a course point closest to a measured position of the target person U as the position on the course CU of the target person U using a coordinate of the measured position of the target person U and coordinates of course points included in a predicted movement range in which the target person U is predicted to move. For example, as illustrated in FIG. 8, the course matching processing unit 313 calculates distances dist0, dist1, dist2, dist3, dist4, dist5, . . . between a measured first position of the target person U and coordinates of course points with CourseIndex=0, 1, 2, 3, 4, 5, . . . included in the predicted movement range and sets a course point with CourseIndex=2 as the first position on the course CU of the target person U because the distance dist2 is the shortest.

Then, the course matching processing unit 313 stores, in the course position information database 324, course position information in which the CourseIndex and the coordinate of the course point set as the position on the course CU of the target person U are linked with a positioning time and speed. That is, course position information of the target persons U is stored in time series in the course position information database 324.

The data output unit 314 transmits the course position information of the target persons U stored in the course position information database 324 to the display terminal 4 through the communication network 6. The display terminal 4 acquires the course position information of the target persons U, displays the image IMG illustrated in FIG. 3, and, when the icon PT is clicked, displays detailed information such as position coordinates and speed of the target persons U included in the course position information.

### 1-4. Course Matching Processing Before and After a Turning Point

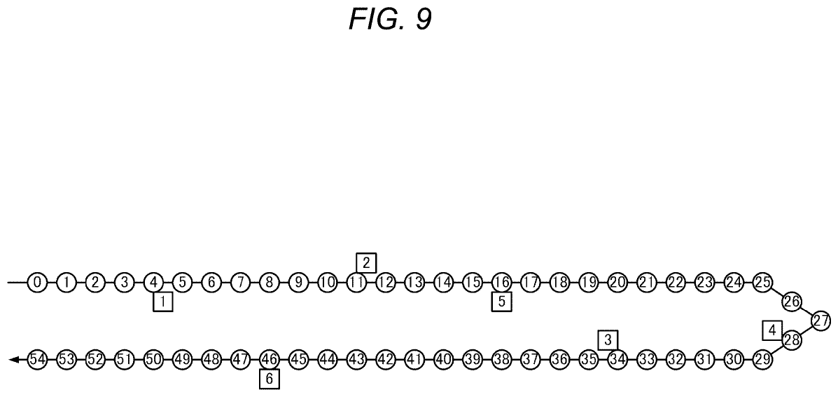

As explained above, the course matching processing unit 313 basically sets, as the position on the course CU of the target person U, the course point closest to the measured position of the target person U among the plurality of course points included in the predicted movement range of the target person U. That is, the course matching processing unit 313 basically performs processing with the predicted movement range of the target person U set as a target range of course matching. However, in this processing, the course matching processing unit 313 may set a wrong course point before and after a turning point. For example, as illustrated in FIG. 9, it is assumed that a course point with CourseIndex=27 among fifty-five course points with CourseIndex=0 to 54 is the turning point.

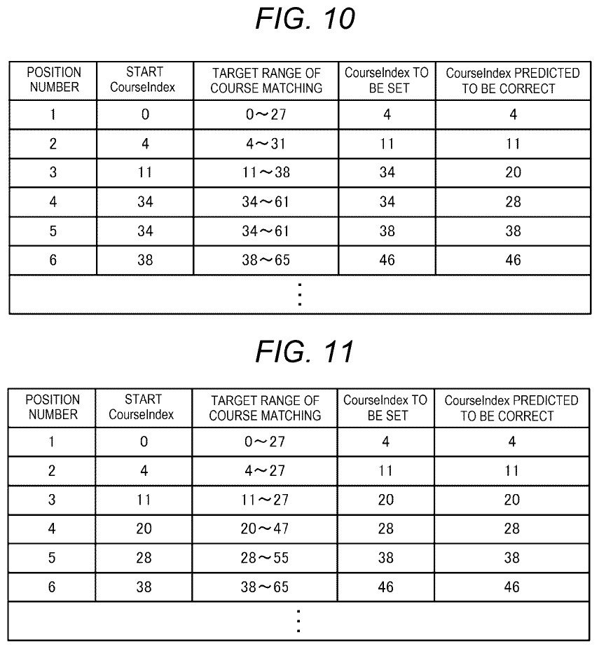

When it is assumed that the number of course points included in the predicted movement range is fixed to twenty-eight and the position on the course CU of the target person U is initially set to a course point with CourseIndex=0, the predicted movement range includes twenty-eight course points with CourseIndex=0 to 27 as start CourseIndex=0 indicating CourseIndex of a leading course point of the predicted movement range of the target person U. Therefore, as illustrated in a first row of a table of FIG. 10, the course matching processing unit 313 calculates a distance between the measured first position of the target person U and each of the twenty-eight course points with CourseIndex=0 to 27 included in the target range of the course matching. As illustrated in FIG. 9, since the measured first position of the target person U is closest to a course point with CourseIndex=4 among the twenty-eight course points with CourseIndex=0 to 27, the course matching processing unit 313 sets CourseIndex=4 as the first position on the course CU of the target person U as illustrated in the first row of the table of FIG. 10.

Since the first position on the course CU of the target person U is set as the course point with CourseIndex=4, start CourseIndex=4 is set and twenty-eight course points with CourseIndex=4 to 31 are included in the next predicted movement range. Therefore, as illustrated in a second row of the table of FIG. 10, the course matching processing unit 313 calculates a distance between a measured second position of the target person U and each of twenty-eight course points with CourseIndex=4 to 31 included in the target range of the course matching. As illustrated in FIG. 9, since the measured second position of the target person U is closest to a course point with CourseIndex=11 among the twenty-eight course points with CourseIndex=4 to 31, the course matching processing unit 313 sets CourseIndex=11 as a second position on the course CU of the target person U as illustrated in the second row of the table of FIG. 10.

Since the second position on the course CU of the target person U is set as the course point with CourseIndex=11, start CourseIndex=11 is set and twenty-eight course points with CourseIndex=11 to 38 are included in the next predicted movement range. Therefore, as illustrated in a third row of the table of FIG. 10, the course matching processing unit 313 calculates a distance between a measured third position of the target person U and each of the twenty-eight course points with CourseIndex=11 to 38 included in the target range of the course matching. As illustrated in FIG. 9, since the measured third position of the target person U is closest to a course point with CourseIndex=34 among the twenty-eight course points with CourseIndex=11 to 38, the course matching processing unit 313 sets CourseIndex=34 as the third position on the course CU of the target person U as illustrated in the third row of the table of FIG. 10.

Since the third position on the course CU of the target person U is set as the course point with CourseIndex=34, start CourseIndex=34 is set and twenty-eight course points with CourseIndex=34 to 61 are included in the next predicted movement range. Therefore, as illustrated in a fourth row of the table of FIG. 10, the course matching processing unit 313 calculates a distance between a measured fourth position of the target person U and each of the twenty-eight course points with CourseIndex=34 to 61 included in the target range of the course matching. As illustrated in FIG. 9, since the measured fourth position of the target person U is closest to the course point with CourseIndex=34 among the twenty-eight course points with CourseIndex=34 to 61, the course matching processing unit 313 sets CourseIndex=34 as the fourth position on the course CU of the target person U as illustrated in the fourth row of the table of FIG. 10.

Since the fourth position on the course CU of the target person U is set as the course point with CourseIndex=34, the start CourseIndex=34 is set and the twenty-eight course points with CourseIndex=34 to 61 are included in the next predicted movement range. Therefore, as illustrated in a fifth row of the table of FIG. 10, the course matching processing unit 313 calculates a distance between a measured fifth position of the target person U and each of the twenty-eight course points with CourseIndex=34 to 61 included in the target range of the course matching. As illustrated in FIG. 9, since the measured fifth position of the target person U is closest to a course point with CourseIndex=38 among the twenty-eight course points with CourseIndex=34 to 61, the course matching processing unit 313 sets CourseIndex=38 as a fifth position on the course CU of the target person U as illustrated in the fifth row of the table of FIG. 10.

Since the fifth position on the course CU of the target person U is set as the course point with CourseIndex=38, the start CourseIndex=38 is set and twenty-eight course points with CourseIndex=38 to 65 are included in the next predicted movement range. Therefore, as illustrated in a sixth row of the table of FIG. 10, the course matching processing unit 313 calculates a distance between a measured sixth position of the target person U and each of the twenty-eight course points with CourseIndex=38 to 65 included in the target range of the course matching. As illustrated in FIG. 9, since the measured sixth position of the target person U is closest to a course point with CourseIndex=46 among the twenty-eight course points with CourseIndex=38 to 65, the course matching processing unit 313 sets CourseIndex=46 as the sixth position on the course CU of the target person U as illustrated in the sixth row of the table of FIG. 10.

When the course matching processing explained above is performed, as illustrated in FIG. 10, course points with CourseIndex=4, 11, 34, 34, 38 and 46 are set in this order as positions on the course CU of the target person U before and after the turning point. Actually, since what is predicted to be correct is a time series of course points with CourseIndex=4, 11, 20, 28, 38, and 46, two course points with CourseIndex=20 and 28 are erroneously set as two course points with CourseIndex=34 and 38.

Thus, in the present embodiment, when a leading course point of the predicted movement range is not included in a first range from the turning point, the course matching processing unit 313 sets, as the position on the course CU of the target person U, a course point closest to a measured position of the target person U among a plurality of course points included in the predicted movement range of the target person U and the range from the leading course point of the predicted movement range to the turning point. That is, when the leading course point of the predicted movement range is not included in the first range from the turning point, the course matching processing unit 313 limits a target range of the course matching to a range up to the turning point and does not set a course point ahead of the turning point as a target of the course matching even if the course point is included in the predicted movement range.

When the leading course point of the predicted movement range is included in the first range from the turning point, the course matching processing unit 313 sets, as the position on the course CU of the target person U, the course point closest to the measured position of the target person U among the plurality of course points included in the predicted movement range of the target person U. That is, when the leading course point of the predicted movement range is included in the first range from the turning point, the course matching processing unit 313 cancels the limitation of the target range of the course matching and sets the course point ahead of the turning point as the target of the course matching when the leading course point is included in the predicted movement range.

In the present embodiment, in order for the course matching processing unit 313 to determine whether the course points are the turning point, as explained above, the course information 322 includes the detailFlag indicating whether the course points are the check point and the detailFlag is set to 1 with the turning point set as the check point.

The first range is determined considering assumed upper limit speed of the target person U, a positioning period of the measurement terminal 2, and the like. For example, when it is assumed that an upper limit of a distance that the target person U runs in one second is 8 m, the target person U passes a maximum of eight course points in one second. Therefore, when it is assumed that a positioning period of the measurement terminal 2 is one second, for example, ten course points before the turning point are included in the first range with a margin.

The first range may be variable according to the measurement accuracy of the position of the target person U and the speed of the target person U. For example, when the measurement information includes information concerning a positioning error, the course matching processing unit 313 may calculate the first range based on the positioning error. Specifically, the course matching processing unit 313 may increase the number of course points included in the first range as the positioning error is larger. For example, when the measurement information includes information concerning the speed of the target person U, the course matching processing unit 313 may calculate the first range based on the speed of the target person U. Specifically, the course matching processing unit 313 may increase the number of course points included in the first range as the speed of the target person U is higher.

In the case of the example illustrated in FIG. 9 explained above, when it is assumed that the position on the course CU of the target person U is initially set as the course point with CourseIndex=0, the start CourseIndex=0 is set and the predicted movement range of the target person U includes twenty-eight course points with CourseIndex=0 to 27. When it is assumed that ten course points with CourseIndex=17 to 26 before the turning point are included in the first range, the leading course point of the predicted movement range is not included in the first range. However, all of the twenty-eight course points with CourseIndex=0 to 27 included in the predicted movement range are course points before the turning point. Therefore, the twenty-eight course points are included in the target range of the course matching. For that reason, as illustrated in a first row of a table of FIG. 11, the twenty-eight course points with CourseIndex=0 to 27 are set as the target range of the course matching. Therefore, as illustrated in the first row of the table of FIG. 11, the course matching processing unit 313 calculates a distance between the measured first position of the target person U and each of the twenty-eight course points with CourseIndex=0 to 27 included in the target range of the course matching. As illustrated in FIG. 9, since the measured first position of the target person U is closest to the course point with CourseIndex=4 among the twenty-eight course points with CourseIndex=0 to 27, the course matching processing unit 313 sets CourseIndex=4 as the first position on the course CU of the target person U as illustrated in the first row of the table of FIG. 11.

Since the first position on the course CU of the target person U is set as the course point with CourseIndex=4, start CourseIndex=4 is set and twenty-eight course points with CourseIndex=4 to 31 are included in the next predicted movement range. Since a leading course point of the predicted movement range is not included in the first range, four course points with CourseIndex=28 to 31 ahead of a turning point included in the predicted movement range are excluded from the target range of the course matching. For that reason, as illustrated in a second row of the table of FIG. 11, twenty-four course points with CourseIndex=4 to 27 are set as the target range of the course matching. Therefore, as illustrated in a second row of the table of FIG. 11, the course matching processing unit 313 calculates a distance between a measured second position of the target person U and each of the twenty-four course points with CourseIndex=4 to 27 included in the target range of the course matching. As illustrated in FIG. 9, since the measured second position of the target person U is closest to the course point with CourseIndex=11 among the twenty-four course points with CourseIndex=4 to 27, the course matching processing unit 313 sets CourseIndex=11 as the second position on the course CU of the target person U as illustrated in the second row of the table of FIG. 11.

Since the second position on the course CU of the target person U is set as the course point with CourseIndex=11, start CourseIndex=11 is set and twenty-eight course points with CourseIndex=11 to 38 are included in the next predicted movement range. Since a leading course point of the predicted movement range is not included in the first range, eleven course points with CourseIndex=28 to 38 ahead of a turning point included in the predicted movement range are excluded from the target range of the course matching. For that reason, as illustrated in a third row of the table of FIG. 11, seventeen course points with CourseIndex=11 to 27 are set as the target range of the course matching. Therefore, as illustrated in the third row of the table of FIG. 11, the course matching processing unit 313 calculates a distance between a measured third position of the target person U and each of the seventeen course points with CourseIndex=11 to 27 included in the target range of the course matching. As illustrated in FIG. 9, since the measured third position of the target person U is closest to a course point with CourseIndex=20 among the seventeen course points with CourseIndex=11 to 27, the course matching processing unit 313 sets CourseIndex=20 as the third position on the course CU of the target person U as illustrated in the third row of the table of FIG. 11.

Since the third position on the course CU of the target person U is set as the course point with CourseIndex=20, start CourseIndex=20 is set and twenty-eight course points with CourseIndex=20 to 47 are included in the next predicted movement range. Since a leading course point of the predicted movement range is included in the first range, twenty course points with CourseIndex=28 to 47 ahead of a turning point included in the predicted movement range are also included in the target range of the course matching. For that reason, as illustrated in a fourth row of the table of FIG. 11, twenty-eight course points with CourseIndex=20 to 47 are set as the target range of the course matching. Therefore, as illustrated in the fourth row of the table of FIG. 11, the course matching processing unit 313 calculates a distance between a measured fourth position of the target person U and each of the twenty-eight course points with CourseIndex=20 to 47 included in the target range of the course matching. As illustrated in FIG. 9, since the measured fourth position of the target person U is closest to a course point with CourseIndex=28 among the twenty-eight course points with CourseIndex=20 to 47, the course matching processing unit 313 sets CourseIndex=28 as the fourth position on the course CU of the target person U as illustrated in the fourth row of the table of FIG. 11.

Since the fourth position on the course CU of the target person U is set as the course point with CourseIndex=28, start CourseIndex=28 is set and twenty-eight course points with CourseIndex=28 to 55 are included in the next predicted movement range. Since a leading course point of the predicted movement range has passed a turning point with CourseIndex=27 and is not included in the first range from the next turning point (not shown), as illustrated in a fifth row of the table of FIG. 11, twenty-eight course points with CourseIndex=28 to 55 included in the predicted movement range are set as the target range of the course matching. Therefore, as illustrated in the fifth row of the table of FIG. 11, the course matching processing unit 313 calculates a distance between a measured fifth position of the target person U and each of the twenty-eight course points with CourseIndex=28 to 55 included in the target range of the course matching. As illustrated in FIG. 9, since the measured fifth position of the target person U is closest to the course point with CourseIndex=38 among the twenty-eight course points with CourseIndex=28 to 55, the course matching processing unit 313 sets CourseIndex=38 as the fifth position on the course CU of the target person U as illustrated in the fifth row of the table of FIG. 11.

Since the fifth position on the course CU of the target person U is set as the course point with CourseIndex=38, the start CourseIndex=38 is set and twenty-eight course points with CourseIndex=38 to 65 are included in the next predicted movement range. Since a leading course point of the predicted movement range is not included in a first range from the next turning point (not shown), as illustrated in a sixth row of the table of FIG. 11, the twenty-eight course points with CourseIndex=38 to 65 included in the predicted movement range are set as the target range of the course matching. Therefore, as illustrated in the sixth row of the table of FIG. 11, the course matching processing unit 313 calculates a distance between a measured sixth position of the target person U and each of the twenty-eight course points with CourseIndex=38 to 65 included in the target range of the course matching. As illustrated in FIG. 9, since the measured sixth position of the target person U is closest to the course point with CourseIndex=46 among the twenty-eight course points with CourseIndex=38 to 65, the course matching processing unit 313 sets CourseIndex=46 as the sixth position on the course CU of the target person U as illustrated in the sixth row of the table of FIG. 11.

By performing the course matching processing explained above, as illustrated in FIG. 11, course points with CourseIndex=4, 11, 20, 28, 38 and 46 are set in this order as the position on the course CU of the target person U before and after the turning point. Therefore, a time series of the course points set as the position on the course CU of the target person U coincides with a time series of course points predicted to be correct.

### 1-5. Position Management Method

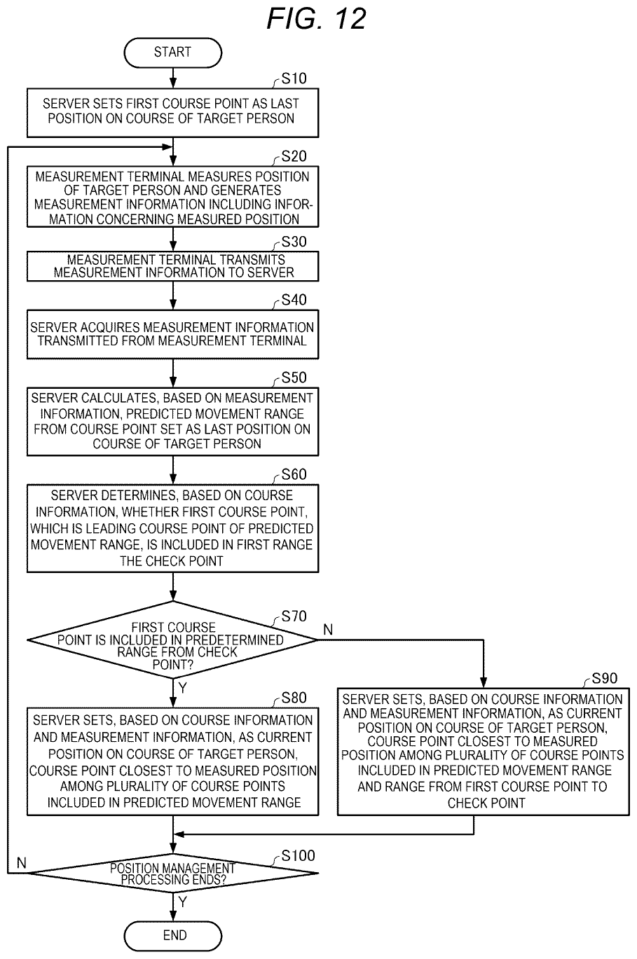

FIG. 12 is a flowchart illustrating a procedure of a position management method by the position management system 1.

As illustrated in FIG. 12, first, in step S10, the server 3 sets, as the last position on the course CU of the target person U, a first course point of the course CU included in the course information 322 transmitted from the measurement terminal 2.

Subsequently, in step S20, the measurement terminal 2 measures the position of the target person U and generates measurement information including information concerning the measured position. In step S20, the measurement terminal 2 may further calculate the speed of the target person U based on the position of the target person U and generate measurement information including information concerning the position and the speed of the target person U. In step S20, the measurement terminal 2 may further calculate a measurement error of the position of the target person U, that is, a positioning error, and generate measurement information including information concerning the position of the target person U and the positioning error. In step S20, the measurement terminal 2 may further calculate the speed of the target person U and a positioning error and generate measurement information including information concerning the position, speed, and positioning error of the target person U.

Subsequently, in step S30, the measurement terminal 2 transmits the measurement information generated in step S20 to the server 3.

Subsequently, in step S40, the server 3 acquires the measurement information transmitted from the measurement terminal 2.

Subsequently, in step S50, the server 3 calculates, based on the measurement information, a predicted movement range from a course point set as the last position on the course CU of the target person U. For example, when the measurement information includes information concerning the speed of the target person U, the server 3 may calculate the predicted movement range based on the speed of the target person U. Specifically, the server 3 calculates a predicted movement range in which a farther course point from the set course point is included as the speed of the target person U is higher. For example, when the measurement information includes information concerning a positioning error, the server 3 may calculate a predicted movement range based on the positioning error. Specifically, the server 3 calculates a predicted movement range in which a farther course point from the set course point is included as the positioning error is larger.

The predicted movement range may include a fixed number of course points regardless of the speed or the positioning error. In this case, the server 3 may not perform the processing in step S50.

Subsequently, in step S60, the server 3 determines, based on the course information 322, whether a first course point, which is a leading course point of the predicted movement range, is included in a first range from a check point.

Then, when the first course point is included in the first range from the check point in step S70, in step S80, the server 3 sets, based on the course information 322 and the measurement information, as the current position on the course CU of the target person U, a course point closest to the measured position of the target person U among a plurality of course points included in the predicted movement range.

When the first course point is not included in the first range from the check point in step S70, in step S90, the server 3 sets, based on the course information 322 and the measurement information, as the current position on the course CU of the target person U, a course point closest to the measured position of the target person U among the plurality of course points included in the predicted movement range and a range from the first course point to the check point.

Then, in step S100, the measurement terminal 2 and the server 3 cooperate to repeatedly perform the processing in steps S20 to S90 until the position management processing is ended.

The processing in steps S10 and S60 to S90 is performed by the course matching processing unit 313 of the server 3. The processing in step S20 is performed by the measurement information generation unit 200 of the measurement terminal 2. The processing in step S30 is performed by the communication unit 24 of the measurement terminal 2. The processing in step S40 is performed by the measurement information acquisition unit 311 of the server 3. The processing in step S50 is performed by the predicted movement range calculation unit 312 of the server 3.

The flowchart including steps S20, S30, and S100 in FIG. 12 is equivalent to a flowchart illustrating a procedure of an operation method for the measurement terminal 2. The flowchart including steps S10 and S40 to S100 in FIG. 12 corresponds to a flowchart illustrating a procedure of an operation method of the server 3. The operation method of the server 3 is performed by the CPU 31 executing the program 321. That is, the program 321 is a program for causing a computer to execute the operation method of the server 3.

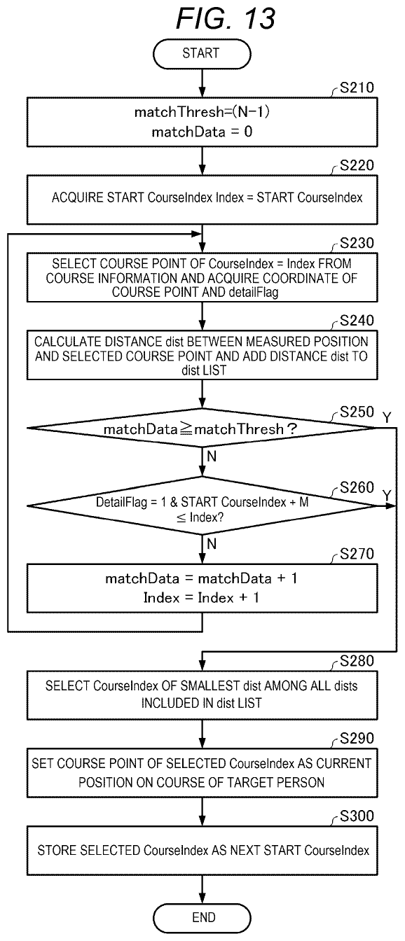

FIG. 13 is a flowchart illustrating an example of a procedure of course matching processing by the course matching processing unit 313. The processing in steps S60 to S90 in FIG. 12 corresponds to the course matching processing.

As illustrated in FIG. 13, first, in step S210, the course matching processing unit 313 sets a constant matchThresh to N−1 and sets a variable matchData to 0. An integer N is the number of course points included in the predicted movement range and is a fixed value in FIG. 13. In the examples explained above with reference to FIGS. 9 and 11, the integer N is 28.

Subsequently, in step S220, the course matching processing unit 313 acquires start CourseIndex and sets the variable Index to the start CourseIndex.

Subsequently, in step S230, the course matching processing unit 313 selects a course point with CourseIndex=Index from the course information 322, and acquires a coordinate of the course point and a value of detailFlag.

Subsequently, in step S240, the course matching processing unit 313 calculates a distance dist between the position of the target person U measured by the measurement terminal 2 and the course point selected in step S230 and adds the distance dist to a dist list.

Subsequently, in step S250, the course matching processing unit 313 compares the variable matchData with the constant matchThresh. Then, if matchData<matchThresh in step S250, in step S260, the course matching processing unit 313 determines whether detailFlag=1 and start CourseIndex+M Index. The integer M is the number of course points included in the first range from the check point. The integer M is 10 in the examples explained above with reference to FIGS. 9 and 11.

When detailFlag=0 or start CourseIndex+M>Index in step S260, in step S270, the course matching processing unit 313 increases the variables matchData and Index respectively by 1 and performs the processing after step S230 again.

On the other hand, when matchData≥matchThresh in step S250 or, when detailFlag=1 and start CourseIndex+M Index in step S260, subsequently, in step S280, the course matching processing unit 313 selects CourseIndex of the smallest dist among all the dists included in the dist list.

Subsequently, in step S290, the course matching processing unit 313 sets the course point with CourseIndex selected in step S280 as the current position on the course CU of the target person U.

Finally, in step S300, the course matching processing unit 313 stores the selected CourseIndex as the next start CourseIndex and ends the processing.

### 1-6. Action and Effects

As explained above, in the position management system 1 in the first embodiment, when the first course point at the head of the predicted movement range from the last position on the course CU of the target person U is not included in the first range, the target of the course matching with the measured position of the target person U is limited to at most the range from the first course point to the check point. Therefore, with the position management system 1 in the first embodiment, it is possible to reduce the likelihood that, when the target person U has not reached a check point such as a turning point, the target person U is mapped to a position on the course CU ahead of the check point.

In the position management system 1 in the first embodiment, when the first course point is included in the first range, the course point ahead of the check point included in the predicted movement range is also a target of the course matching with the measured position of the target person U. Therefore, with the position management system 1 in the first embodiment, it is possible to reduce the likelihood that the target person U is not mapped to a position on the course CU ahead of the check point when the target person U reaches a position close to the check point.

With the position management system 1 in the first embodiment, since the number of course points to be a target of the course matching is appropriately adjusted according to the speed of the target person U and the positioning error, it is possible to reduce a load of the course matching processing.

### 2. Second Embodiment

In the following explanation, concerning the position management system 1 in a second embodiment, the same components as the components in the first embodiment are denoted by the same reference numerals and signs, the same explanation as the explanation in the first embodiment is omitted or simplified, and differences from the first embodiment are mainly explained.

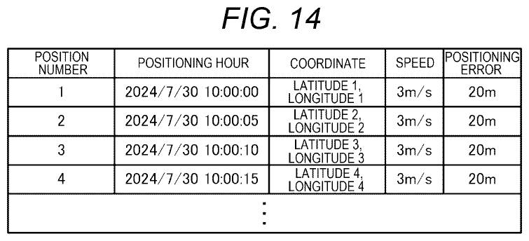

In the first embodiment, since the first course point, which is the leading course point of the predicted movement range of the target person U, is always the course point set as the last position on the course CU of the target person U, a load of the course matching processing increases when the period of the measurement information acquisition unit 311 acquiring the measurement information is longer. For example, when a plurality of course points are set on the course CU at intervals of 1.0 m, as illustrated in FIG. 7, when the measurement information acquisition unit 311 acquires the measurement information at a period of one second, the number of course points included in the predicted movement range is a maximum of twenty-eight considering a positioning error or the like. However, as illustrated in FIG. 14, when the measurement information acquisition unit 311 acquires the measurement information at a period of five seconds, the number of course points included in the predicted movement range is a maximum of 140 and the load of the course matching processing increases. A range of the course point in the target person U is expected to move five seconds later should be narrowed to some extent by the speed of the target person U. For example, when the speed of the target person U is 3 m/s, since the target person U moves 12 m in four seconds, the course matching processing unit 313 may perform the course matching processing with a course point twelve course points ahead of the first course point set as a leading course point of the predicted movement range. Therefore, in the second embodiment, the course matching processing unit 313 calculates the first course point, which is the leading course point of the predicted movement range, based on the period of the measurement information acquisition unit 311 acquiring the measurement information from the measurement terminal 2 and the speed of the target person U.

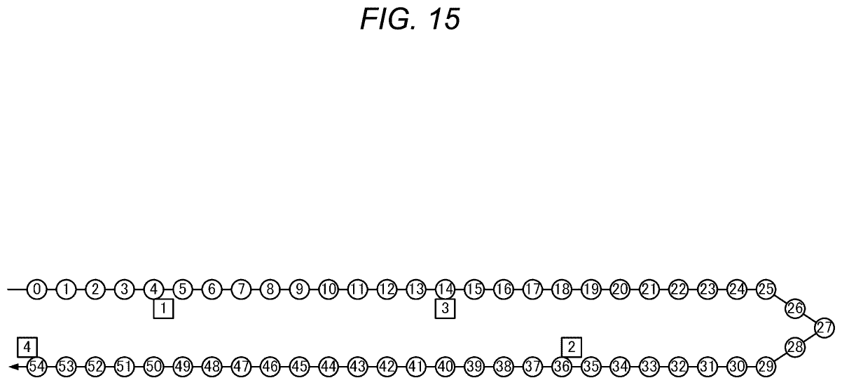

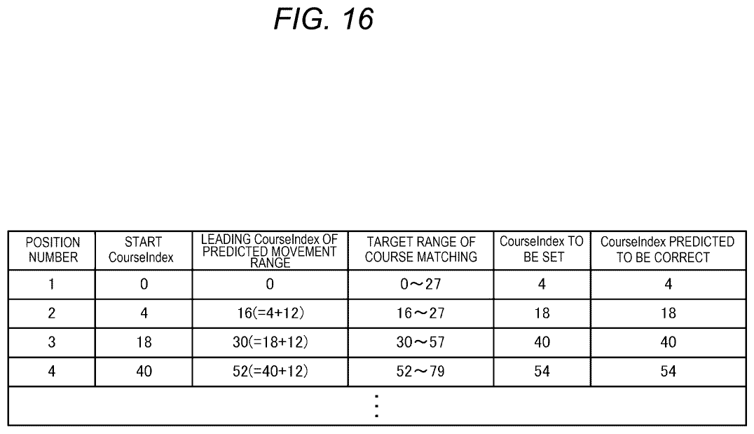

For example, as illustrated in FIG. 15, as in FIG. 9, it is assumed that a course point with CourseIndex=27 among fifty-five course points with CourseIndex=0 to 54 set at intervals of 1.0 m is a turning point. In this case, it is assumed that the measurement information acquisition unit 311 acquires measurement information at a period of five seconds and the course matching processing unit 313 sets CourseIndex=4 as a first position on the course CU of the target person U as illustrated in a first row of the table of FIG. 16.

Since the first position on the course CU of the target person U is set as the course point with CourseIndex=4, when start CourseIndex=4 is set and the speed of the target person U is assumed to be 3 m/s, the next predicted movement range includes twenty-eight course points with CourseIndex=16 to 43 with a course point with CourseIndex=16 (=4+4×3) set as a leading course point. When it is assumed that ten course points with CourseIndex=17 to 26 before the turning point are included in the first range, the leading course point of the predicted movement range is not included in the first range. Therefore, sixteen course points with CourseIndex=28 to 43 before the turning point included in the predicted movement range are excluded from the target range of the course matching. For that reason, as illustrated in a second row of the table of FIG. 16, twelve course points with CourseIndex=16 to 27 are set as the target range of the course matching. Therefore, as illustrated in the second row of the table of FIG. 16, the course matching processing unit 313 calculates a distance between a measured second position of the target person U and each of the twelve course points with CourseIndex=16 to 27 included in the target range of the course matching. As illustrated in FIG. 15, since the measured second position of the target person U is closest to a course point with CourseIndex=18 among the twelve course points with CourseIndex=16 to 27, the course matching processing unit 313 sets CourseIndex=18 as the second position on the course CU of the target person U as illustrated in the second row of the table of FIG. 16.

Since the second position on the course CU of the target person U is set as the course point with CourseIndex=18, when start CourseIndex=18 is set and the speed of the target person U is assumed to be 3 m/s, the next predicted movement range includes twenty-eight course points with CourseIndex=30 to 57 with a course point with CourseIndex=30 (=18+4×3) set as a leading course point. Since the leading course point of the predicted movement range has passed a turning point with CourseIndex=27 and is not included in the first range from the next turning point (not shown), as illustrated in a third row of the table of FIG. 16, the twenty-eight course points with CourseIndex=30 to 57 included in the predicted movement range are set as the target range of the course matching. Therefore, as illustrated in the third row of the table of FIG. 16, the course matching processing unit 313 calculates a distance between a measured third position of the target person U and each of the twenty-eight course points with CourseIndex=30 to 57 included in the target range of the course matching. As illustrated in FIG. 15, since the measured third position of the target person U is closest to a course point with CourseIndex=40 among the twenty-eight course points with CourseIndex=30 to 57, the course matching processing unit 313 sets CourseIndex=40 as the third position on the course CU of the target person U as illustrated in the third row of the table of FIG. 16.

Since the third position on the course CU of the target person U is set as the course point with CourseIndex=40, when start CourseIndex=40 is set and the speed of the target person U is assumed to be 3 m/s, the next predicted movement range includes twenty-eight course points with CourseIndex=52-79 with the course point with CourseIndex=52 (=40+4×3) as the leading course point. Since the leading course point of the predicted movement range has passed the turning point with CourseIndex=27 and is not included in the first range from the next turning point (not shown), as illustrated in a fourth row of the table of FIG. 16, the twenty-eight course points with CourseIndex=52 to 79 included in the predicted movement range are set as the target range of the course matching. Therefore, as illustrated in the fourth row of the table of FIG. 16, the course matching processing unit 313 calculates a distance between the measured fourth position of the target person U and each of the twenty-eight course points with CourseIndex=52 to 79 included in the target range of the course matching. As illustrated in FIG. 15, since the measured fourth position of the target person U is closest to a course point with CourseIndex=54 among the twenty-eight course points with CourseIndex=52 to 79, the course matching processing unit 313 sets CourseIndex=54 as the fourth position on the course CU of the target person U as illustrated in the fourth row of the table of FIG. 16.

By performing the course matching processing explained above, as illustrated in FIG. 16, course points with CourseIndex=4, 18, 40, 54 are set in this order as positions on the course CU of the target person U before and after the turning point. Therefore, a time series of the course points set as the position on the course CU of the target person U coincides with a time series of course points predicted to be correct.

In the example illustrated in FIG. 15, if the course matching processing unit 313 performs the course matching processing with twenty-eight course points always included in the predicted movement range of the target person U set as the target range of the course matching without considering the turning point, course points with CourseIndex=4, 36, 14, 54 are set in this order as the positions on the course CU of the target person U and do not coincide with the time series of the course points predicted to be correct.

Since a flowchart illustrating the procedure of the position management method by the position management system 1 in the second embodiment is the same as FIG. 12, the illustration of the flowchart is omitted. However, in the second embodiment, in step S50, the server 3 calculates the first course point, which is the leading course point of the predicted movement range, based on the period of acquiring the measurement information from the measurement terminal 2 in step S40 and the speed of the target person U included in the acquired measurement information. Since the processing in the other steps of the position management method in the second embodiment is the same as the processing in the first embodiment, the explanation of the processing is omitted.

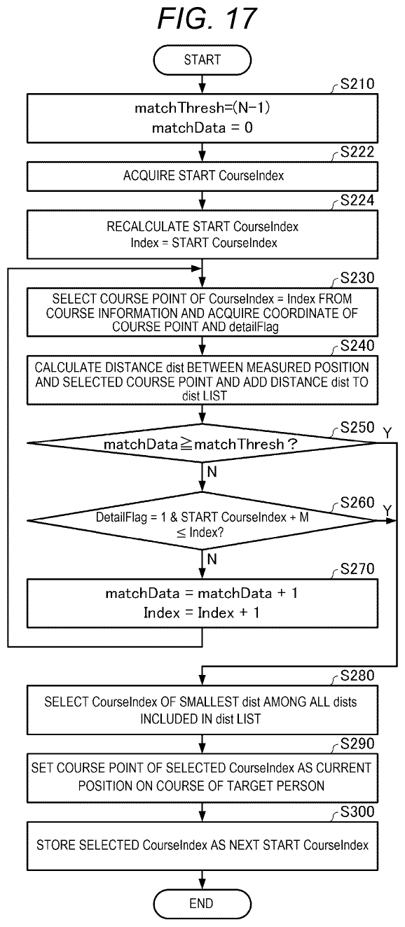

FIG. 17 is a flowchart illustrating an example of a procedure of course matching processing by the course matching processing unit 313 according to the second embodiment. In FIG. 17, the same steps as the steps in FIG. 13 are denoted by the same reference numerals and signs.

In the flowchart illustrated in FIG. 17, step S220 in FIG. 13 is replaced with steps S222 and S224. That is, in step S222, the course matching processing unit 313 acquires a start CourseIndex, and then, in step S224, the course matching processing unit 313 recalculates the start CourseIndex and sets the variable Index to the start CourseIndex. Specifically, in step S224, the course matching processing unit 313 recalculates start CourseIndex based on acquired start CourseIndex, a period for acquiring measurement information from the measurement terminal 2, and the speed of the target person U included in the acquired measurement information. For example, taking the second row of the table of FIG. 16 as an example, the course matching processing unit 313 recalculates start CourseIndex=16 (=4+3×4) for acquired start CourseIndex=4.

Since processing of other steps in the flowchart of FIG. 17 is the same as the processing in FIG. 13, the explanation of the processing is omitted.

With the position management system 1 in the second embodiment explained above, since the leading course point to be a target of the course matching is appropriately adjusted according to the speed of the target person U, in particular, when a period in which the server 3 acquires measurement information is long, a load of the course matching processing can be significantly reduced. Besides, the position management system 1 in the second embodiment achieves the same effects as the effects of the position management system 1 in the first embodiment.

### 3. Modifications

The present disclosure is not limited to the embodiments, and various modifications can be made within the scope of the gist of the present disclosure.

For example, in the embodiments explained above, the steps of the flowchart of FIG. 12 are executed by the measurement terminal 2 and the server 3 in cooperation with each other. However, either the measurement terminal 2 or the server 3 may act as, within the possible range, an entity that executes the steps. Other equipment provided in the position management system 1 may execute some of the steps of the flowchart of FIG. 12. That is, the entity that executes the steps of the flowchart of FIG. 12 is not limited to the measurement terminal 2 and the server 3.

The embodiments and the modifications explained above are examples and are not limited thereto. For example, the embodiments and the modifications can be combined as appropriate.

The present disclosure includes substantially the same components as the components explained in the embodiments, for example, components having the same functions, methods, and results or components having the same objects and effects. The present disclosure includes configurations obtained by replacing non-essential portions of the components explained in the embodiments. The present disclosure includes components that can achieve the same action effects as or components that can achieve the same objects as those of the components explained in the embodiments. The present disclosure includes configurations obtained by adding a publicly-known technique to the components explained in the embodiments.

The following contents are derived from the embodiments and the modifications explained above.

A position management method according to an aspect is a position management method for managing a position on a course of a target person, the position management method including:
a measurement terminal measuring a position of the target person and generating measurement information including information concerning the measured position;
the measurement terminal transmitting the measurement information to a server;
the server acquiring the measurement information transmitted from the measurement terminal;
the server determining, based on course information including coordinates of a plurality of course points including a check point on the course, whether a first course point, which is a leading course point in a predicted movement range from a course point set as a last position on the course of the target person among the plurality of course points, is included in a first range from the check point; and
when the first course point is not included in the first range from the check point, the server setting, based on the course information and the measurement information, among a plurality of course points included in the predicted movement range and a range from the first course point to the check point, a course point closest to the measured position as a current position on the course of the target person.

In this position management method, when the leading first course point of the predicted movement range from the last position on the course of the target person is not included in the first range, a target of course matching with the measured position is limited to at most the range from the first course point to the check point. Therefore, with the position management method, it is possible to reduce the likelihood that the target person is mapped to a position on the course ahead of the check point when the target person has not reached the check point.

The position management method according to the aspect may further include, when the first course point is included in the first range from the check point, the server setting, based on the course information and the measurement information, as a current position on the course of the target person, a course point closest to the measured position among the plurality of course points included in the predicted movement range.

In this position management method, when the leading first course point of the predicted movement range from the last position on the course of the target person is included in the first range, the course point ahead of the check point included in the predicted movement range is also a target of the course matching with the measured position. Therefore, with the position management method, it is possible to reduce the likelihood that the target person is not mapped to a position on the course ahead of the check point when the target person has reached a position close to the check point.

In the position management method according to the aspect,
the measurement information may include information concerning speed of the target person, and
the position management method may further include the server calculating the predicted movement range based on the speed.

With the position management method, since the number of course points to be targets of the course matching is appropriately adjusted according to the speed of the target person, it is possible to reduce a load of the course matching processing.

In the position management method according to the aspect, in the calculating the predicted movement range, the server may calculate the first course point based on a period of acquiring the measurement information from the measurement terminal and the speed of the target person.

With the position management method, since the leading course point to be a target of the course matching is appropriately adjusted according to the speed of the target person, it is possible to significantly reduce the load of the course matching processing particularly when the period of acquiring the measurement information is long.

In the position management method according to the aspect,
the measurement information may include information concerning a measurement error of the position of the target person, and
the position management method may further include the server calculating the predicted movement range based on the measurement error.

With the position management method, since the number of course points to be targets of the course matching is appropriately adjusted according to the measurement error of the position of the target person, it is possible to reduce the load of the course matching processing.

In the position management method according to the aspect, the check point may be a turning point.

With the position management method, it is possible to reduce the likelihood that the target person is mapped to a position on the course ahead of the turning point when the target person has not reached the turning point.

A position management method according to another aspect is a position management method for managing a position on a course of a target person, the position management method including:
acquiring measurement information including information concerning the position of the target person;
determining, based on course information including coordinates of a plurality of course points including a check point on the course, whether a first course point, which is a leading course point in a predicted movement range from a course point set as a last position on the course of the target person among the plurality of course points, is included in a first range from the check point; and
when the first course point is not included in the first range from the check point, setting, based on the course information and the measurement information, among a plurality of course points included in the predicted movement range and a range from the first course point to the check point, a course point closest to the measured position as a current position on the course of the target person.

In this position management method, when the leading first course point of the predicted movement range from the last position on the course of the target person is not included in the first range, a target of course matching with the measured position is limited to at most the range from the first course point to the check point. Therefore, with the position management method, it is possible to reduce the likelihood that the target person is mapped to a position on the course ahead of the check point when the target person has not reached the check point.

An operation method of a server according to another aspect is an operation method of a server for storing course information including coordinates of a plurality of course points including a check point on a course, the operation method including:
acquiring measurement information including information concerning a position of a target person transmitted from a measurement terminal;
determining, based on the course information, whether a first course point, which is a leading course point in a predicted movement range from a course point set as a last position on the course of the target person among the plurality of course points, is included in a first range from the check point; and
when the first course point is not included in the first range from the check point, setting, based on the course information and the measurement information, among a plurality of course points included in the predicted movement range and a range from the first course point to the check point, a course point closest to the measured position as a current position on the course of the target person.

In the operation method of the server, when the leading first course point of the predicted movement range from the last position on the course of the target person is not included in the first range, a target of course matching with the measured position is limited to at most the range from the first course point to the check point. Therefore, with the operation method of the server, it is possible to reduce the likelihood that the target person is mapped to a position on the course ahead of the check point when the target person has not reached the check point.

A non-transitory computer-readable storage medium stores a program according to another aspect that causes a computer to execute the operation method of the server.

A position management system according to another aspect of the present disclosure is a position management system that manages a position on a course of a target person, the position management system including:
a measurement terminal; and
a server, wherein
the measurement terminal includes:
   a measurement information generation unit configured to measure a position of the target person and generate measurement information including information concerning the measured position; and
   a communication unit configured to transmit the measurement information to the server, and
the server includes:
   a data storage unit configured to store course information including coordinates of a plurality of course points including a check point on the course;
   a measurement information acquisition unit configured to acquire the measurement information transmitted from the measurement terminal; and
   a course matching processing unit configured to determine, based on the course information, whether a first course point, which is a leading course point in a predicted movement range from a course point set as a last position on the course of the target person among the plurality of course points, is included in a first range from the check point and, when the first course point is not included in the first range from the check point, set, based on the course information and the measurement information, among a plurality of course points included in the predicted movement range and a range from the first course point to the check point, a course point closest to the measured position as a current position on the course of the target person.

In this position management system, when the leading first course point of the predicted movement range from the last position on the course of the target person is not included in the first range, a target of course matching with the measured position is limited to at most the range from the first course point to the check point. Therefore, with the position management system, it is possible to reduce the likelihood that the target person is mapped to a position on the course ahead of the check point when the target person has not reached the check point.

What is claimed is:

1. A position management method for managing a position on a course of a target person, the position management method comprising:
a measurement terminal measuring a position of the target person and generating measurement information including information concerning the measured position;
the measurement terminal transmitting the measurement information to a server;
the server acquiring the measurement information transmitted from the measurement terminal;
the server determining, based on course information including coordinates of a plurality of course points including a check point on the course, whether a first course point, which is a leading course point in a predicted movement range from a course point set as a last position on the course of the target person among the plurality of course points, is included in a first range from the check point; and
when the first course point is not included in the first range from the check point, the server setting, based on the course information and the measurement information, among a plurality of course points included in the predicted movement range and a range from the first course point to the check point, a course point closest to the measured position as a current position on the course of the target person.

2. The position management method according to claim 1, further comprising, when the first course point is included in the first range from the check point, the server setting, based on the course information and the measurement information, as a current position on the course of the target person, a course point closest to the measured position among the plurality of course points included in the predicted movement range.

3. The position management method according to claim 1, wherein
the measurement information includes information concerning speed of the target person, and
the position management method further comprises the server calculating the predicted movement range based on the speed.

4. The position management method according to claim 3, wherein, in the calculating the predicted movement range, the server calculates the first course point based on a period of acquiring the measurement information from the measurement terminal and the speed of the target person.

5. The position management method according to claim 1, wherein
the measurement information includes information concerning a measurement error of the position of the target person, and
the position management method further comprises the server calculating the predicted movement range based on the measurement error.

6. The position management method according to claim 1, wherein the check point is a turning point.

7. An operation method of a server for storing course information including coordinates of a plurality of course points including a check point on a course, the operation method comprising:
acquiring measurement information including information concerning a position of a target person transmitted from a measurement terminal;
determining, based on the course information, whether a first course point, which is a leading course point in a predicted movement range from a course point set as a last position on the course of the target person among the plurality of course points, is included in a first range from the check point; and
when the first course point is not included in the first range from the check point, setting, based on the course information and the measurement information, among a plurality of course points included in the predicted movement range and a range from the first course point to the check point, a course point closest to the measured position as a current position on the course of the target person.

8. A non-transitory computer-readable storage medium storing a program, the program causing a computer to execute the operation method of the server according to claim 7.

9. A position management system that manages a position on a course of a target person, the position management system comprising:
a measurement terminal; and
a server, wherein
the measurement terminal includes:
a measurement information generation unit configured to measure a position of the target person and generate measurement information including information concerning the measured position; and
a communication unit configured to transmit the measurement information to the server, and
the server includes:
a data storage unit configured to store course information including coordinates of a plurality of course points including a check point on the course;
a measurement information acquisition unit configured to acquire the measurement information transmitted from the measurement terminal; and
a course matching processing unit configured to determine, based on the course information, whether a first course point, which is a leading course point in a predicted movement range from a course point set as a last position on the course of the target person among the plurality of course points, is included in a first range from the check point and, when the first course point is not included in the first range from the check point, set, based on the course information and the measurement information, among a plurality of course points included in the predicted movement range and a range from the first course point to the check point, a course point closest to the measured position as a current position on the course of the target person.
